(19) United States
(12) Patent Application Publication
(10) Pub. No.: US 2011/0251902 A1
(43) Pub. Date: Oct. 13, 2011

(54) Target Area Based Content and Stream Monetization Using Feedback

(75) Inventor: Nagendra Nagarajayya, Pleasanton, CA (US)

(73) Assignee: transaxtions llc, Pleasanton, CA (US)

(21) Appl. No.: 13/081,605

(22) Filed: Apr. 7, 2011

Related U.S. Application Data
(60) Provisional application No. 61/322,899, filed on Apr. 11, 2010.
(60) Provisional application No. 61/325,356, filed on Apr. 18, 2010.

(51) Int. Cl. G06Q 30/00; G06F 15/16

(52) U.S. Cl. 705/14.71; 709/203

(57) ABSTRACT

A system and method to increase monetization of event streams with relevant content such as advertising, games, puzzles, sensory output, etc. using target areas on a client device. The target area enables contextually relevant advertisement objects to be streamed in from a server device. The target areas enable the event streams and user generated content to be sold as cost-per-time, click-sale, click, impressions, etc. increasing monetization revenue, brand awareness and traffic.

### FIELD OF THE INVENTION

The present invention relates to displaying advertising in targeted areas on a client device with a timing mechanism. The timing mechanism enables dynamic content to be streamed from a server device to the client device. The targeted areas on the client device enables relevant streaming content and user generated content to be monetized.

### BACKGROUND OF THE INVENTION

Advertising is a communication medium allowing a product or a service to be sold. Advertising enables creation of brand loyalty and increasing brand awareness. Advertising media can be television, newspapers, internet, radio, cinema, magazines, billboards, etc. Advertising can be traced to early periods, as early as the Egyptians advertising on papyrus. Early advertising was more pictorial then text as the general populace could not read and write, but the printing press changed advertising, people became more knowledgeable and could read and write. Advertisements became part of newspapers, magazines, radio, televisions, [etc.]. and with the introduction of computer systems and the development of the internet became a part of it. Internet companies now rely solely on this medium as their revenue model. Advertising on the internet or on a network is text and graphics with sound. Text advertising is usually some text followed by a link so that when a user clicks on the link the user is transferred to the advertiser site. Text enables relevant advertising to be shown to the context of a page or a search. Images are usually shown as banners and are used to increase brand awareness. Text associated with images is used to increase the relevancy of the banners or images shown. The text in the above said advertising is usually static while images can be grouped together to create exciting dynamic content.

The advertisement and content on the internet is usually viewed through a browser application. The text and images are formatted as HTML. HTML is a tag language and is generally used to describe the content. HTML can also be associated with JavaScript. JavaScript allows dynamic actions to be associated with the tag language and can also be used to provide a rich experience. Advertising, similar to what is seen on televisions can be enabled per page with media and sound.

Advertising is sold either by allocating space on a page to show banner images or text links or embedding rich media clients, etc. The advertisements are downloaded from servers and displayed in the allocated space. Online Newspapers, Magazines, Blogs, etc. make money selling these spaces to advertisers. This invention describes a new way to add to the monetization revenue per page by providing these content providers to sell any content on the page as advertising.

Streaming media from the server side is monetized by inserting advertising before the start of an event and at the end of the event. The advertising inserted is clips of streaming media. Advertising is also inserted into the event stream mixing it with the event stream and is usually shown at the bottom of the event stream, etc. The advertising shown might not be relevant to the events in the stream making the user lose focus. This invention describes a new way to show relevant content in real time including advertising, games, puzzles, surveys, sensory output, etc. on target areas which can reside on the event stream or outside of the event stream in real time. The advertising shown is relevant to the what is being seen in the event. For eg. If the event shows rabbits running round a city, then advertising shown will be related to rabbits or carrots. If the rabbits are running around in New York, the advertising shown will be related to the city of New York like sight seeing activities, vacation ideas, vacation rentals, hotels, etc. or if the event is a sports event, then advertising shown would be related to the event, like the basketball in use in a basketball game or if the event is tennis then racquets/clubs/hotels/jewelry, etc. or if golf, then clubs/courses/vacations/hotels, etc. or if skiing, tickets/equipment/vacations, etc. or if cricket bats/clothes/fitness, etc. or if nascar, cars/parts/vacations, etc. or if soccer, balls/tickets/hotels, etc or if baseball, cards/baseball tickets/equipment, etc. The advertising being shown since it is relevant to the events in the event stream catches attention increasing brand awareness, traffic and monteziation of the event stream. The advertisements are mixed dynamically onto the visual being rendered as before linearly, at the beginning or end of the stream or as non-linear in-stream overlays or in-stream text rendered outside of the event stream in real-time with personalization, sentiments and sensory feedback increasing the reach and effect of the advertisement.

### BRIEF DESCRIPTION OF THE INVENTION

Advertising on the net is very dynamic from videos to banner images to text based ads. This invention describes using a client device with a timing means and a server device to create and sell target areas on the client device allowing these target areas to receive streaming content like advertising, games, puzzles, etc. from a server device allowing relevant content to be displayed along with the event stream, enabling increased monetization of the stream while also increasing brand awareness and traffic. This invention also describes a way for content owners to monetize own or partner generated content, in addition to advertisements shown to increase per page monetization.

### BRIEF DESCRIPTION OF THE DRAWINGS

The accompanying drawings, which are incorporated into and constitute a part of this specification, illustrate one or more embodiments of the present invention and, together with detailed description, serve to explain the principles and implementations of the invention.

FIG. 1 is an illustration of the advertisement system.

FIG. 2, 2-1 is a flow chart illustrating the flow of information between the client and server device.

FIG. 3, 3-1 is a flow chart illustrating the flow of information between the server device and the advertisement server on a request from a client device.

FIG. 4 is an illustration of an advertisement object.

FIG. 5, 5-1 is a flow chart of a customer creating an advertisement.

FIG. 6 is a flow chart of a publisher injecting an advertisement into publisher content.

FIG. 7, 7-1 is a flow chart illustrating a click on an advertisement.

FIG. 8 is a flow chart illustrating a feedback input generation with human intelligence.

FIG. 9 is a flow chart illustrating a feedback input generation with machine intelligence.

FIG. 10 is a flow chart illustrating sending contextually relevant advertisement objects in real time.

### REFERENCES CITED

U.S. PUBLISHED APPLICATIONS

| | | | |
|---|---|---|---|
| 20070226189 | Aug. 31, 2006 | John William; et al | 707/3 |
| 20070288314 | May 25, 2007 | Cao; Yu; et al | 705/14 |
| 20060277167 | May 19, 2006 | Gross; William; et al | 707/3 |

### OTHER REFERENCES

### Parents Case Text

### CROSS-REFERENCE TO RELATED APPLICATIONS

This application is related to US patent application number 20090171790, titled “Time based targeted advertising” filed Jul. 2, 2009 by the present applicant.

This application is related to U.S. provisional patent application No. 61,322,899, titled “Target Area Based Content Monetization” filed Apr. 11, 2010 by the applicant.

This application is related to U.S. provisional patent application No. 61,325,356, titled “Target Area Based Stream Monetization Using Feedback” filed Apr. 18, 2010 by the applicant.

This application is related to US patent application number 20080104047, titled “INTELLIGENT SEARCH WITH GUIDING INFO” filed Mar. 1, 2008 by the present applicant.

### DETAILED DESCRIPTION OF PREFERRED EMBODIMENTS

Embodiments of the present invention are described herein in the context of a method and apparatus for emulating a competitive process. Those of ordinary skill in the art will realize that the following detailed description of the present invention is illustrative only and is not intended to be in any way limiting. Other embodiments of the present invention will readily suggest themselves to such skilled persons having the benefit of the disclosure. Reference will now be made in detail to the implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business related constraints, and that these specific goals will vary from one implementation to another and from one developer to another. Moreover, it will be appreciated that such a development effort might be complex and time consuming, but would nevertheless be routine undertaking of engineering for those of ordinary skill in the art having the benefit of this disclosure.

In accordance with the present invention, the components, process steps, and/or data structures may be implemented using various types of operating systems, computing platforms, computer programs, and or/general purpose machines. In addition, those of ordinary skill in the art will recognize that devices of a less general purpose nature such as hardwired devices, field programmable gate arrays (FPGAs), application specific integrated circuits (ASICs), or the like, may also be used without departing from the scope and spirit of the inventive concepts disclosed herein.

A number of terms are used herein to describe features of embodiments of the present invention.

As used herein, the term “advertisement” will be used to refer to any of a number of formats (known and to be developed) for showing content to an operator or user or viewers or customer, [etc.] As used herein, the term “advertisement” may be used to refer to the content shown on a client device display. The content may include text, graphics, media streams, sound, sensory outputs, etc. The advertisement may include a title, image, description, a visual link and an actual link to transfer control on a click, etc.

As used herein, the phrase “computer system” is usually made up of a processor, memory, storage, network, clock, input devices and output devices. Input devices can be a keyboard, a pointer device such as a mouse, touch screen, [etc.]. Output devices usually are display, printers, plotters, and controllers, [etc.]. The brain of a computer system is usually the processor such as a microprocessor. A microprocessor executes machine level instructions that enable it to perform logic as well as communicate with the input and output devices. The machine level instructions can be executed with dedicated electronic circuits or use a higher level programmable code that enables the microprocessor to execute a task. The computer system usually at startup, loads an operating system (OS) that manages the input and output devices and also enables executing higher level applications. A server device is a computer based system that usually responds to a client device request. The server device executes a server application that can listen to client requests and respond back with a response. A client device is again a computer based system that communicates across a network 140 with a server device for content. The client device can be a thin client or a thick client. In a thin client, the client device does not handle much processing other than collect input send it across to the server for processing and output the response from the server onto the output devices on the client, like a display, [etc.]. In a thick client, the client device might run an operating system itself, do more processing and communicate with the server device as needed. The communication is usually handled by higher level applications being executed on the client device which make use of networking means to communicate.

As used herein, the phrase “client device” 120 will be used to refer to the device used by a user to view the advertisement. The phrase “client device” has also been used broadly to refer to client applications executing on the device. The client device can be a general purpose computer system with a processor, storage, network connectivity and a display. The client device usually executes a client application, maybe a browser that can communicate across a network with a server device and retrieve content. The retrieved content is shown on the client display. The browser can also execute program code such as JavaScript, Java, [etc.]. Client applications like the browser makes use of the clock signals generated on the client device to enable timer services allowing program code to be executed at regular intervals.

As used herein, the phrase “server device” 150 may be used to refer to a device that executes a server application waiting to respond to a client request. The phrase “server device” has been broadly used to refer to server applications executing on the server device. On a client request such as a request from a browser, the server application sends back content that can be shown on the browser. The content can be text, graphics, sound, media streams, etc. A server device might execute a plurality of server applications, and in an embodiment a server application might itself act as a client and make requests to other server applications executing on the server device or other server devices on the network. A server device usually handles concurrent requests from a plurality of client devices. In an embodiment a plurality of server devices may appear as one to a plurality of client devices to handle the incoming client requests and to scale in performance.

As used herein, the term “browser” 130 may be used to refer to a client application that usually executes on a client device. A web browser is usually referred to as a browser application that is used to browse content on the internet/intranet from a server device. The content usually is tag language based such as HTML but can be others such as XML, XHTML, etc. The browser usually has the capability to show other content. HTML is a tag based language and uses tags to identify content. An HTML document is organized into sections with a “<begin> and “<end>” tag. It begins with a <HTML> tag followed by a <HEAD> tag (section), followed by a <BODY> tag (section). A body tag acts as a container for other tags like <TABLE>, <DIV>, <SPAN>, <P>, <FONT>, [etc.]. The browser renders HTML content onto the display device making use of any Cascading Style Sheets (CSS) usually in the HEAD section to format and style the content rendered. HTML enables a viewer to enjoy print quality visuals on the display. HTML can be associated with program code to create rich action oriented applications. A browser usually includes a program code interpreter or provides such a functionality to execute the program code associated with HTML. A browser also makes use of the timer functionality on a client device enabling program code to be executed at timer intervals. Program code sign up for these timer services using convenience function calls, such as settimer(function, delay), setinterval(function, delay) and clearinterval(id).

As used herein, the term “display” may be used to refer to the display device connected to the client device that allows content to be shown. Display is a piece of electrical equipment usually connected to the video source of the client device. The display can show text, graphics, generate sound, and maybe linked to/show sensory outputs, [etc.]. Display devices usually are (Liquid Crystal Display) LCD based but can be (Cathode Ray Tube) CRT, Plasma or Light Emitting Diode based, [etc.]. Display devices can be part of the client device as in a laptop/tablet/smart phone or separated from the client device as in a general purpose computer.

As used herein, the phrase “clock signal” may be used to refer to a timing means that generates a clock signal periodically on the client device. The client device usually offers a low level Application Programmable Interface (API) enabling an operating system or client device applications to make use of these signals to offer timer services, scheduling, [etc.] Timer services enable program code like shell scripts, application binary code, or at a higher level, an application like a browser with a program code interpreter to offer operating system type of timer services.

As used herein, the phrase “target area” will be used to refer to an area on the display device that can be used to show content. Content can be text, graphics, media streams, and sound. The target area can be a simple <DIV> tag container in an embodiment. A <DIV> tag is part of the HTML tag language. A <DIV> tag container can be very powerful especially with CSS and offers almost the capability of the <BODY> tag. The <DIV> tag is rendered by the browser on to the display device as part of the HTML page being shown on the display device. A <DIV> tag has the following attributes an id, width, height, title, style. The id attribute can be used to target a <DIV> container so that content can be rendered with JavaScript program code without affecting content on other parts of the display device. To render content in an embodiment, the <DIV> tag id is looked up using a convenience method such as getElementByid, and an attribute such as innerHTML to render. Other ways of doing this would be to inject HTML language tags into the Document Object Model (DOM) of the browser application, thereby rendering content onto the display on a refresh. In another embodiments, the target area container can be linked to or a sensory output device enabling sensory content to be displayed. Sensory content can be text, graphics, sound mixed with signals to control changing the intensity of vibrations, color, smell/aroma, touch, feel, thermal, location, movement, etc.

As used herein, the phrase “program code” will be used to refer to code executed in a computer based system. Program code can be in interpreted form or compiled form. In interpreted form the code is at a high level in the form of a programming language and is interpreted one line at a time to execute the code. In compiled form, the program code is analyzed and compiled into a binary form that the computer system can understand and execute as instructions. The operating system of the computer system is usually in compiled form and enables executing applications, tasks, communicate across a network, with input and output devices, [etc.]. Applications can also interpret program code or compile such code to offer more services. A browser is one such application that allows content to be retrieved from a server device. The content is usually HTML. The browser usually executes a JavaScript interpreter so HTML which is a tag language can be associated with dynamic actions. JavaScript is an object oriented language, allowing HTML to be rendered, managed and manipulated on the display device. JavaScript also enables input, output and communication with a server device. A <script> tag usually identifies program code to be executed. The src attribute of the <script> tag is a link and can point to a file containing program code to be executed. The browser while parsing HTML content on recognizing a <script> tag loads the program code from the server device and executes the code using the JavaScript interpreter. The code on execution can create new HTML tags, JavaScript objects, render content, sign up with the timer service, [etc.].

As used herein, the phrase “data object” refers to an object with attributes and methods. Attribute is a specification that defines a property and is usually in the form of a name and value pair. Attributes usually have a type and rules for using the type. A type might be integer, long, character or String, Object, [etc.]. An object of a type integer may allow numbers from 0 to 2̂31−1 to be stored and operated upon. An integer object might be unsigned or signed allowing negative numbers. A character object might store values between 0 and 2̂16−1. A String object might be made up of multiple character objects in sequence. An object method is like a function call but with a namespace and visibility of just the object. Object methods enable manipulating the attributes of the object, like setting or retrieving the attribute value, [etc.] Objects can be extended or aggregated to form higher level types allowing complex structures to be represented and operated upon as objects. An Address object might have attributes, street, description, city, zipcode, state, and country where street might be a String object, description again might be a String object, city might be a String object, zipcode might be a Zipcode object, state might be State object and country might be a Country object. An Address object is an aggregation of multiple objects, while a Zipcode might be an extension of the String object with addition of another String object. The first String object in a Zipcode maybe named zip, while the second String object maybe named geography. The two attributes allow a Zipcode of the form postcode-geography. Methods of the form get Zip, and storeZip enables retrieving and storing zipcodes.

As used herein, the phrase “click” refers to a click or change in state of an input device such as a mouse or a joystick button, etc. in a computer based system.

As used herein, the phrase “link” refers to an URL. URLs are Uniform Resource Locators and are of the form http://login:password@address/context?querystring. Address can be a numeric such as an IP address or a hostname.domainname.com. query string can be of the form “parameter=value”.

As used herein, the phrase “customer” refers to a customer who creates advertisements on the server device using a client device. The customer pays for the advertisements shown on the client device. The billing may be daily, monthly, prepaid, post-paid, [etc.]

As used herein, the phrase “fixed price” refers to a type of advertisement pricing wherein the price of an advertisement to be shown is fixed. The fixed price can be configured on the server device and can be specific to a target area where the advertisement is to be shown. The fixed price can change with demand. A fixed price type has priority over a bid price type. The priority enables a fixed price advertisement to be shown even if there is a bid price advertisement available and has a higher price. The fixed price guarantees to the customer that it will be shown on the target area.

As used herein, the phrase “bid price” refers to a type of advertisement price wherein the customer bids with other customers on the price to show an advertisement. The bidding is of a forward auction type.

As used herein, the phrase “cost-sale” refers to a type of advertisement price wherein the customer does not pay to show an advertisement but pays a commission on the sale of an item resulting from showing the advertisement. The user is transferred to the customer site on a click on a link in the advertisement.

As used herein, the phrase “cost-per-time” refers to a type of advertisement price wherein the customer pays to show an advertisement for a time period.

As used herein, the terms “impressions, per-click, click-sale, cost-per-time” refers to the type of billing for an advertisement. An impression is an impression of an advertisement on a client device. Impressions allow billing a customer for showing the advertisement on a client device. The billing could be per impression or one thousand impressions also known as Cost per mil (CPM), [etc.]. Per-click is a click on the target area where an advertisement is being shown or a click on a link in the advertisement. The click is tracked and allows the customer to be billed. Click-sale is a click followed by a sale of a product being advertised or a product from the customer site. The customer is not billed for the click, but pays a commission as part of the sale. Cost-per-time is a way to increase monetization revenue of a page by selling target areas on a page for time. The time period could be as short as a second to months, etc. The target areas can show contents generated by a site or a partner or a server device.

As used herein, the phrase “query-terms” refers to parameters passed from the client device to the server device as part of a request for an advertisement. Query terms can be keywords or terms of a search such as city, state, country, adults, children, product, hotel, airfare, vacation, cruise, [etc.] The query term enables the server device to match the query-term to an attribute target terms, [etc.] in the data objects on the server device and select matching data objects to send back to the client device.

As used herein, the phrase “target-terms” refers to an attribute in the data object allowing the query-terms parameter sent by the client-device to be matched. The server device on receiving a request, uses an index to find matching advertisement object keys. In an embodiment the index might be constructed by feeding the advertisement objects to an index writer. The index writer breaks down the object attributes such as name, description, target terms into words and adds them to index. The index might be of type inverted index. To match using the index, the server device might use an index searcher that goes through the said index and finds all the documents with words that match the said terms. The matching documents could then be used to retrieve keys to the advertisement objects. The matching objects are then returned by the server and can be included in a response.

As used herein, the phrase “trapping a click in the target area” refers to capturing a click in a target area or on a link being shown in the target area. A click can be easily captured in the target area through a JavaScript function attached to the <DIV> tag through the onclick attribute. Similarly, a click on a link can be captured through a JavaScript function attached to anchor tag (<A>) onclick attribute.

As used herein, the terms “tracking a click”, “count”, “client attributes” refer to a click on an advertisement and communicating the said click to the server device. In an embodiment, it can be done by creating an image tag dynamically with the src attribute taking as parameters click id, advertisement id, target area, [etc.]. The client device sends across the image request back to the server device. The server device logs will reflect the value of the src attribute which can be processed later for billing the customer. Similarly the count value can be transferred back to the server device for billing. Every request usually will have the client attributes, ip address and session id. Additional parameters like affiliate id can also be passed so that affiliate performance can be tracked to enable paying a commission to an affiliate. In other embodiments, a click can be sent across to a server device using an XMLHttpRequest.

As used herein, the terms “sale price”, “discount percentage”, “compare link”, “compare identifier” refer to a data object with these attributes 423. The data object with these said attributes are created by a customer on the server device or sent as part of a data feed to the server device. The sale price, discount percentage and a compare link are displayed on the display device along with other attributes. A user click on the compare link is captured and a request is made to the server device address in the compare link along with at least the compare identifier as a parameter. In an embodiment, the server device address can be different from the server device that sent in the initial advertisement data object. The compare identifier enables the server device to send comparison shopping content. Comparison shopping content can be product items with the matching product codes but from different customers with different prices. The comparison shopping content is displayed on the client display. Each product shown on the display could have customer links. A click on these links usually enables the client device to retrieve content from the customer server device allowing a user of the client device to complete a sale.

As used herein, the terms “title”, “description”, “show link”, “click link” are attributes of a data object 420 shown as an advertisement on the client display device. The title might be shown in a different color compared to the description and the show link attribute, and might be rendered as a link. The “show link” value is usually the shortened meaningful address of the customer server device, while the click link attribute contains the link address of the customer server device to retrieve content from, on a click.

As used herein, the terms “count”, “count threshold” are attributes of a data object 420 and enable the program code to show a data object on the client display for that many count clock signals. Once the count threshold is crossed, the program code changes the current object to the next object to be shown. A data object usually is a cyclical link list of objects.

As used herein, the terms “Ajax”, “XmlHttpRequest” refers to the ability of the client application like a browser executing on a client device to communicate with the server device to retrieve content asynchronously. The XmlHttpRequest can be initiated on a clock signal or a count threshold trigger or a click to retrieve content from the server device; said content can be selectively refreshed onto the display device using a tag like <DIV>. Before the availability of XmlHttpRequest, a request by a browser would stop and pause functions until the request was completed. The returned content was updated as a complete HTML page and caused a flicker as well as long waits. XmlHttpRequest and selective refresh of the client display enables rich application experience with just HTML and JavaScript.

As used herein, the terms “xsocket-http”, “reverse Ajax”, “Server push” refers to the ability of the server device to push content asynchronously to a client device. The server device starts the content push based on an initial request for content from the client device and pushes the content on changes or events on the server devices or client devices. Such events on the server side might be timing means like clock signal timers, or a change of state communication from a client device such as a click or input means. Server push eliminates the need for polling the server device for content by the client device using a clock signal. Polling can be expensive in terms of resources used, while asynchronous server push eliminates the cost of these expensive resources.

As used herein, the terms “websockets”, refers to the ability to communicate between a client and server device in full duplex using TCP communications protocol. Websockets enables port 80, port usually used for browser-server communications and through firewalls to use the http protocol for TCP communications. The TCP communications is layered on top of http protocol with some extra overhead. This is a very useful protocol but is usually not enabled in browsers due to security limitations.

As used herein, the phrase “website” refers to a server device and a server application 160 on the server device that is able to respond back with content, usually HTML based, but could offer other services like email, cloud computing, ftp, [etc.]. A website usually has a name or an IP address. If it has a name it is registered with a name registry so that it can be discovered by users on the internet. The name is usually of the form http/www.name.XXX., where XXX is a Top Level Domain Name (TLD).

As used herein, the phrase “Object converter” refers to a object converter that allows objects with attributes to be represented as Extended Markup Language (XML) or in JavaScript Object Notation (JSON). XML is a tag language that can be used to describe objects with attributes, schemas, [etc.]. HTML tag language is nothing else but XML and is used to describe content to be shown on a display device. XML can be used to describe a Java or a JavaScript language object. The advantage of using XML to describe a language object is it makes the object portable across operating systems, computer systems, and also allows objects to be sent across networks. JSON is another way of representing objects and represents object attributes as name, value pairs. Object converter provides methods that allow a language object to be converted to XML/JSON, and from JSON/XML back to the language objects.

As used herein, the phrase “Advertisement server” 170 refers to a server application on a server device that sends back data objects and program code based on a request. The program code can be script code and in an embodiment can be JavaScript. The data objects are objects with attributes and in a JavaScript embodiment can be JavaScript objects. In other embodiments they can be Java language objects [etc.] An Object converter is made use of to send data objects to a client. One of the parameters of a request is the type of objects, as an XML or JSON object. If a data object is sent as a JSON object, then there is no conversion required on the browser since it is a JavaScript object 230. The other parameters maybe query terms, affiliate id, client attributes, [etc.]. The query terms enable the server to select the data objects relevant to the query terms.

Another job of an Advertisement server 170 is to enable creation of the data objects 530 by customers 185. The customers access the advertisement server using a client device 180 and send parameters to create/modify/manage an advertisement 500. This enables the advertisement server to send back graphical user content enabling the customer to create data objects with attributes, creating an advertisement 510. An advertisement can be perceived as a data object, made up of attributes and methods 400. The data object gets converted into text and graphics on the client device by the program code into a viewable form. The advertisement data object might include attributes target area, fixed or bid type or click-sale, fixed price (read only attribute), bid price, target terms, [etc.] 410. The advertisement object further aggregates multiple data objects 420, 421, 422, . . . as a list 560. The data objects in the list have at least attributes title, description, show link, click link and a count threshold. The data object attributes may also include price, discount percentage, product code, compare link, compare identifier, image link, [etc.] 423. The data objects in the list might be created as a sequence of objects in an embodiment. The sequence allows the objects to be linked creating a cyclical structure. The advertisement object methods traverse the list to return the current object, update attributes, keep track of current object, count of objects, [etc.].

The customer creates an advertisement object by choosing a target area on the client device, chooses a price type,—if the price is fixed type, the price to show the data object on the target area is made available by the server device 540. If it is of bid type, the customer chooses a bid price to pay—creates the data objects 550 with attributes title, description, show link, click link, [etc.] in sequence, chooses the count threshold for each data object and sets target terms if advertisement is to be targeted towards a set of query terms 540. In an embodiment, the bid price set by the customer may need to be higher than the minimum bid criteria set for a target area. The customer may also choose that the advertisement server automatically choose a target area to display the advertisement.

In other embodiments, a customer might also create an advertisement object with attributes, product name, description, sale price, discount percentage, product code, show link, compare link, target terms, price type, [etc.]. The advertisement server converts these attributes into a form as above into a data object with attributes title, description, show link, clink link, compare link, compare id, [etc.]. The customer instead of creating the advertisement through a graphical user interface might send across the advertisement objects as a data feed or using an Application Programmable Interface (api).

The graphical user interface also enables the customer to group advertisement objects into an advertisement campaign 520, 570. The advertisement campaign is again a data object with attributes such as a name, budget, a daily spending limit, start date, end date or no end date. The budget attribute limits the advertisement expenditure to a set budget and stops the group of advertisements from being shown once the budget threshold is crossed. The daily spending limit is again a similar threshold limiting expenditure per day. The start date and end date attributes enables the group of advertisements to be shown for the period. A “no end date” shows the group, until budget thresholds are crossed.

A plurality of campaign objects can be created to create groups of advertisement objects. The plurality of campaign objects are grouped under a customer object with attributes such as name, company, address, email, user id, password, [etc.]. A daily limit attribute in the customer object allows spending expenditure to be limited across campaigns. Payment attributes, such as a credit number, card name, card type, enable customer to be billed for an advertisement.

The graphical user interface also allows the customer to view performance of the campaigns and billing statements. A performance summary shows the daily, monthly, yearly performance of the campaigns by impressions, clicks and charge. The daily and monthly performance summary allows further viewing the details by day, [etc.]. The campaign performance activity shows performance by campaign, money spent, daily impressions, clicks, charge, [etc.]. Links allow viewing details by each advertisement and client attributes such as client device address, session id, [etc.]. Billing statements made to the customer can also be viewed.

Yet another job of an advertisement server is to enable a publisher or a service provider 195 to select target areas on a client display or choose the format of advertising to be shown on the client display. The publisher also connects to the advertisement server through a client display 190. A single or a plurality of advertisements may be shown in a target area. The publisher can choose the number of advertisements, the layout of the advertisement, horizontal layout or vertical layout or line layout, [etc.], the size of the layout, width, height, color of the layout, [etc.] 600. These can be done programmatically or using the graphical user interface. The publisher injects the generated program code, HTML tags into the HTML content on the publisher website allowing the advertisement to be served on a client request 610.

As used herein, the phrase “publisher” or service provider refers to the owner of a website or service on a server device. The publisher 195 owns or has access to the content that is served through the web server or server device 620. The publisher to monetize the content serves advertisements along with content to be shown on the client device. The publisher in an embodiment embeds these advertisements in the form of text, graphics using tags like <script>, <div>[etc.]. The advertisements could be just simple text or images or media streams, program code and data objects. The program code and data objects could be retrieved from an advertisement server executing on the same server device or on another server device. The publisher refers to an advertisement server device using the src attribute of the <script> tag, and chooses a target area where the advertisement should be shown on the display device by specifying the id attribute of the <div> tag in an embodiment. The publisher can generate “a bundle” programmatically or through a graphical user interface 190 of the advertisement server that allows the publisher to generate these. In an embodiment the publisher uses a graphical user interface to create “a bundle”. The publisher takes the bundle object and adds it to the content on the server device. In an embodiment, the publisher can use programmable apis to create “a bundle” and embed the bundle into the content.

As used herein, the phrase “site-owner” refers to the owner of a server device. The site-owner 195 owns or has access to the content that is served through the web server or server device 620. The site-owner to monetize the website content serves advertisements along with content to be shown on the client device. The site-owner in an embodiment embeds these advertisements in the form of text, graphics using tags like <script>, <div>[etc.]. The advertisements could be just simple text or images or program code and data objects. The program code and data objects could be retrieved from an advertisement server executing on the same server device or on another server device. The site-owner refers to an advertisement server device using the src attribute of the <script> tag, and chooses a target area where the advertisement should be shown on the display device by specifying the id attribute of the <div> tag in an embodiment. The site-owner can generate “a bundle” programmatically or through a graphical user interface 190 of the advertisement server that allows the publisher to generate these. The site-owner takes the bundle and adds it to the content. In an embodiment, the site-owner can use programmable apis to embed advertisement into the content. The site-owner also generates content, dynamic or static that is served through the server device and shown on the client device.

A site-owner to better monetize per page revenue can identify target areas on the page and create these target areas on the advertisement server device. The site owner chooses attributes target area type, fixed or bid type, fixed or minimum bid price, billing type cost-per-time, ppc, cpm, cpi, etc., billing freq, billing period in time like seconds, day, month, quarter, year, number of periods, content type like text, text-image, image, video or any, site-owner or partner generated or advertisement server generated content, motion, etc. The site-owner uses a graphical user interface or programmable apis to create these in an embodiment. A target area with site-owner generated content now enables the site-owner to sell any content on a page to an advertiser or a customer. The content does not have to appear as an advertisement but can be prime position close to the title of the page, like a link or content on a button (that is clicked thousands of times) increasing brand awareness, traffic and sales/revenue of the customer/advertiser allowing both the site owner to increase monetization as well as the customer/advertiser. The target areas enable the site-owner to now monetize any part of the page or client device with any content not just advertisements. The target areas can show advertisements from an advertisement server device or site-owner generated content or content from a partner. The content shown in these target areas can be customer/advertiser relevant. The site-owner invites customers to sign up to buy these target areas by time, click or impressions. Site-owner generates Javascript code by creating “a bundle” referring to the target area, choosing display, layout, content type, motion, content generation attributes, etc. for the target area. Site-owner embeds Javascript code into web page showing content on the client device. Site-owner also adds the bundle id to the target area so that the bundle program code can identify the target area to track the target area's performance. The customer is billed based on the billing type and frequency created based on impressions, time, ppc, etc.

As used herein, the phrase “target area type” refers to the type of a target area on the client device. The target area type can be a link, static-link, banner-line, banner, area, any, etc. in an embodiment. A static-link is any type of URL link that does not change while a link can show dynamic content with motion. A banner-line target area types shows contents on a client device limiting the content to just one line of some width/height. Similarly a banner is an area on the client of some shape showing a banner type advertisement. A banner target area type usually shows a plurality of advertisement objects from a server device changing the advertisement objects with time. A banner can include text/image/sound, etc. An area is a type of shape on the client device that can not only show text/images but stream in media. The target types described are examples of just an embodiment and more target types could be added as needed.

As used herein, the phrase “layout” refers to the type of a target area layout on the client device. The layout can be horizontal, vertical, line or any in an embodiment. The layout describes the way an advertisement object attributes are rendered in the target area.

As used herein, the phrase “content type” refers to the type of content to be shown in the target area. The content can text, text-image, image, video or any in an embodiment.

As used herein, the phrase “units” refers to the number of advertisement objects shown in the target area.

As used herein, the phrase “advertisement object” refers to an advertisement object with attributes. The attributes include a plurality of ad objects, target area, keywords, content type, display attributes, etc. The ad objects include attributes name, id, description, count thresholds, image, motion, video stream, keywords, target area, etc.

As used herein, the phrase “a bundle” is an advertisement object with attributes on the client device. A bundle is a wrapper object for the server side advertisement object. A bundle includes all server side advertisement object attributes including layout, units, content-type, target area type, bundle id, next tick and adds new attributes for the client device like program code to be executed on the client device, display attributes like length, width, color, etc. The bundle enables the retrieved server side advertisement objects to be connected and acted upon with methods similar to server side methods but on the client device.

As used herein, the phrase “feedback input” is feedback generated using human intelligence or through machine or artificial intelligence. Feedback input can be in the form of identifying the objects or events in an event stream and recording the start/end timeline of the events/objects/actions, etc., generating an id and adding tags identifying/prioritizing the events/objects and actions in the event stream at that particular time. The feedback can have an action associated with the event or object. For. eg. if the event is a movie preview, and at the end of the preview, the movie title or actors in it can be made sticky so that tickets to the movie can be shown. Sticky in an embodiment means prioritize search results to show the feedback which maybe tickets to the movie, overriding other matching results, etc. The feedback can also be a sensory input/output associated with the events in the event stream. In an embodiment feedback can be generated with human intelligence by watching or hearing or playing the event stream with a timeline. At interesting events in the event stream timeline, for eg. a home generated movie stream showing the busy streets of San Francisco, feedback can be input identifying objects in the event stream, like hotels, landmarks, people, etc. while also including the timeline when the identified objects are in focus in the event stream and the duration of the focus. In an embodiment, the feedback can be start time, end time, and relevant text identifying the scene or object. This feedback is generated for the entire stream identifying interesting scenes, objects and events. Once the feedback for an event stream is available, if the event stream is played back by another user or a plurality of users, advertising or content relevant to scene, objects and events in the event stream can now also be streamed to the client device. For eg. If the user is watching the streets of San Francisco, hotels/activities/vacation ideas can be streamed on to the target areas on the client device. The timer means on the client device is used to keep track of the timeline of the stream and is also communicated back to the advertisement server device. The advertisement server device on receiving a request with a time tick, matches the tick to the feedback timeline and uses the feedback input to search through an index matching content relevant to the timeline events. The server device sends back the matching content to the target area and maybe including the next tick when the client device is to communicate with it, enabling the sent back content to be rendered in the target area until the next tick. In an embodiment the specialized client application streaming the event and the advertisement server are synced with the timeline so that any noisy conditions—such as wireless connections—leading to dropped connections, frames, etc. can be handled. This sync also enables user interaction with the specialized client application such as pause/replay/rewind/fast forward, etc. to sync the timeline with the advertisement server device. The content can be text, graphics, media, games, puzzles, surveys, etc. Sending back games or puzzles or forms at time intervals allows the user to now interact with events in the event stream increasing the experience, brand awareness, complete a sale, etc. The input from the text/graphics/game/puzzle/form, sensory inputs, etc. can now be sent back to a server device for further processing. In an embodiment if the feedback is sensory then content or signals can be sent back to the target area enabling a sensory context to be triggered on the client device. In an embodiment the target area can be outside of the player event stream wherein the event stream may need to be played in a specialized client application. In an embodiment the target area can be inside the player streaming the event stream overlaying the event stream. In another embodiment the target area can be within an event stream wherein the event stream will need to be re-encoded including the advertising content in real-time or maybe statically. In an embodiment, the event and feedback can be in real-time enabling machine intelligence or human intelligence to generate feedback on the fly enabling contextual advertisement and actions to be sent back to the client device. In an embodiment the machine intelligence maybe speech or image recognition system or a combination that generates a stream of natural language text that is parsed into contexts using a NLP engine. The contexts are encoded into a timeline that becomes the feedback input for the event stream. The feedback can be enhanced to prioritize events or add actions, etc.

As used herein, the phrase “events or objects or scene” in an event stream or media stream is the actual events being shown in the stream. For eg, buildings in downtown San Francisco or the wharf or golden gate bridge or the park, maybe a hotel, restaurant, etc or a sports events like golf wherein a known golfer is playing golf at a well known course, etc.

As used herein, the phrase “events stream” is the media stream being streamed from a server device. It could be flash, mp3, windows media, quicktime, mpeg4, h.264, Ogg, etc. In an embodiment the event stream is streamed with a specialized application player in a browser.

As used herein, the phrase “context” refers to the context of the events in a stream and can be derived by identifying a sentence and parts, sense tagging it using a sense tagger to associate compound words, associate nearby words by looking through a known index, throwing away adjectives and keep just nouns and verbs, generate synonyms for the associated words to expand feedback generated, etc.

A sense tagger is similar to WordNet::SenseRelate::AllWords open source tagger that allows terms to be tagged with a sense known to Wordnet. It finds the sense of each term related to the surrounding terms based on measures as in Wordnet::Similarity ie. Term sense disambiguation is the task of assigning a sense to a word based on the context in which it occurs.

WordNet® “is a large lexical database of English, developed under the direction of George A Miller (Emeritus). Nouns, verbs, adjectives and adverbs are grouped into sets of cognitive synonyms (synsets), each expressing a distinct concept. Synsets are interlinked by means of conceptual-semantic and lexical relations. The resulting network of meaningfully related words and concepts can be navigated with the browser. WordNet is also freely and publicly available for download. WordNet's structure makes it a useful tool for computational linguistics and natural language processing”.

As used herein, the phrase “passing through the known index” refers to looking up a term with sense, maybe throwing away an adjective but looking up nouns, verbs, etc. in the known index or a knowledgebase such as a Wikipedia topic title and forming sub contexts or maybe adding new compound contexts such as “mortgage”, “loans” or “mortgage_loans” or little people or small people as Lilliput or dwarfs or hobbits, etc.

### System

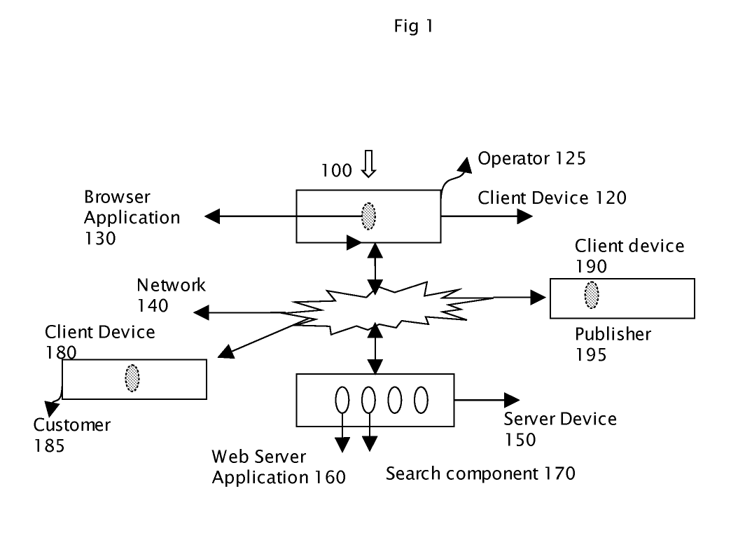

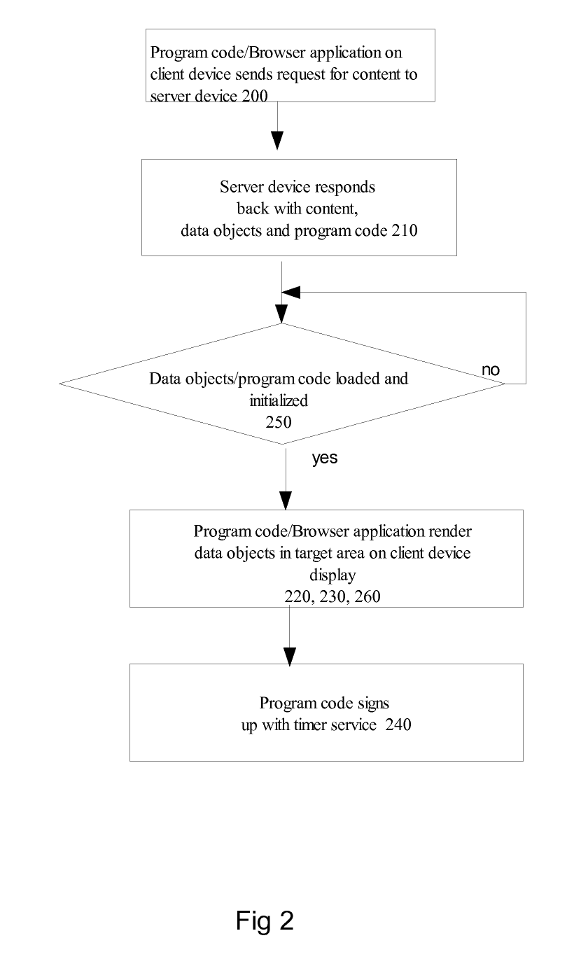

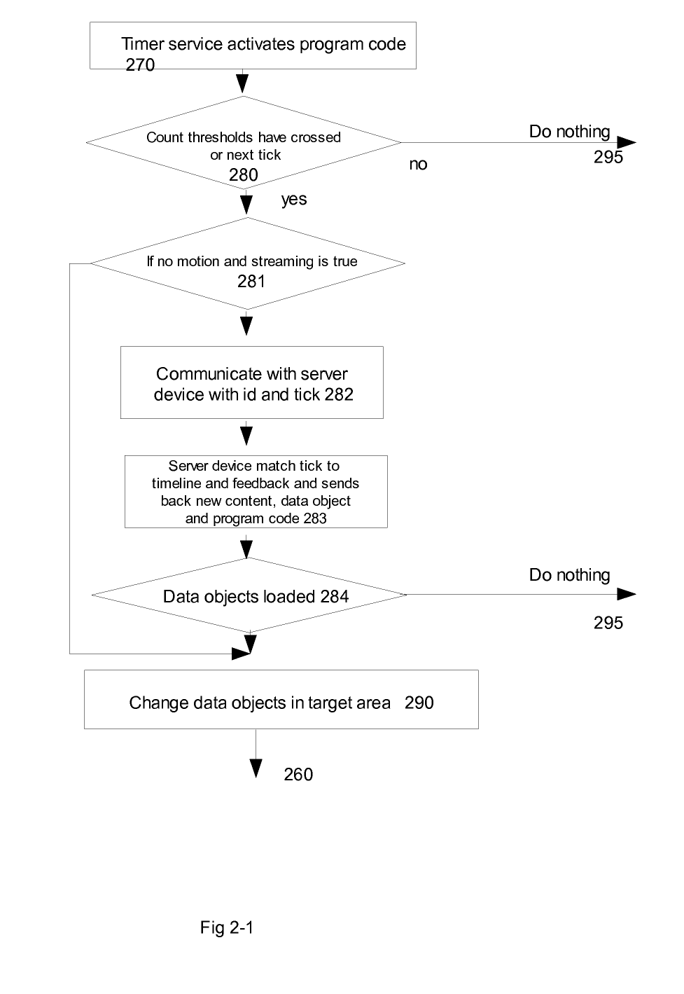

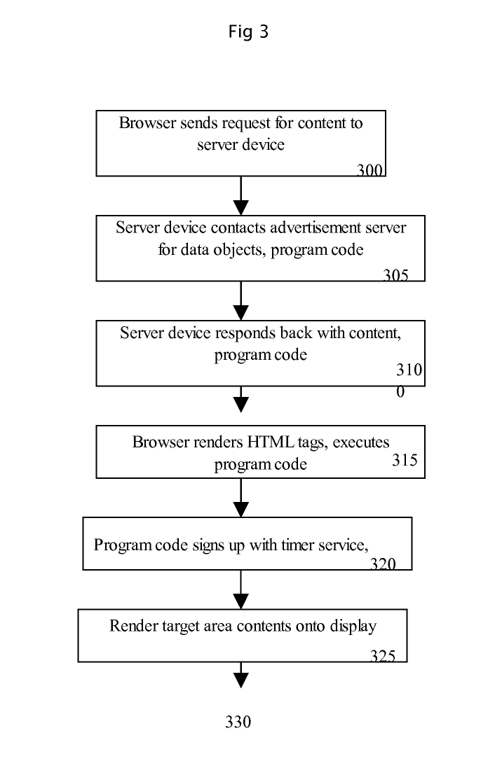

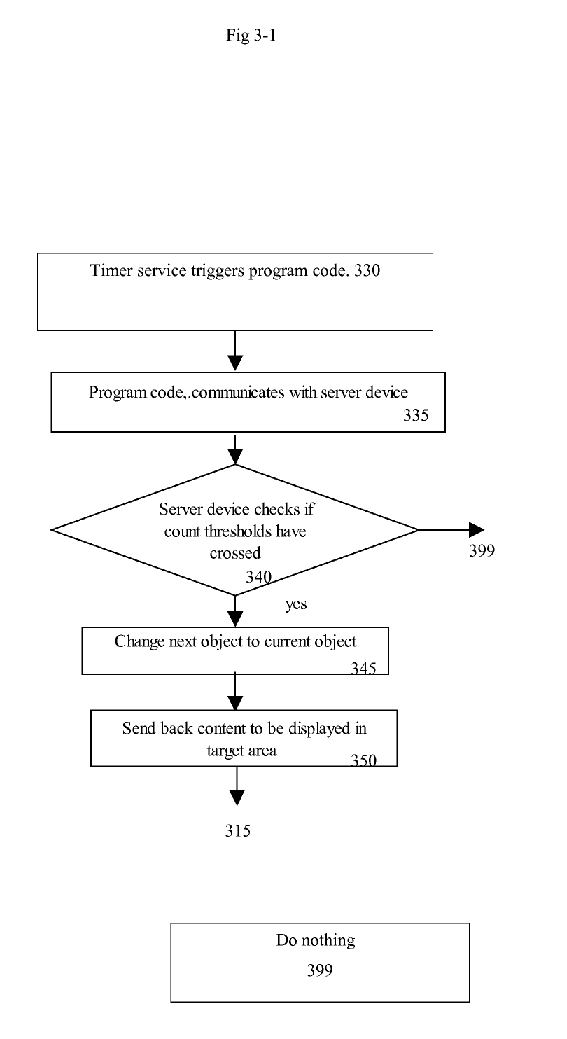

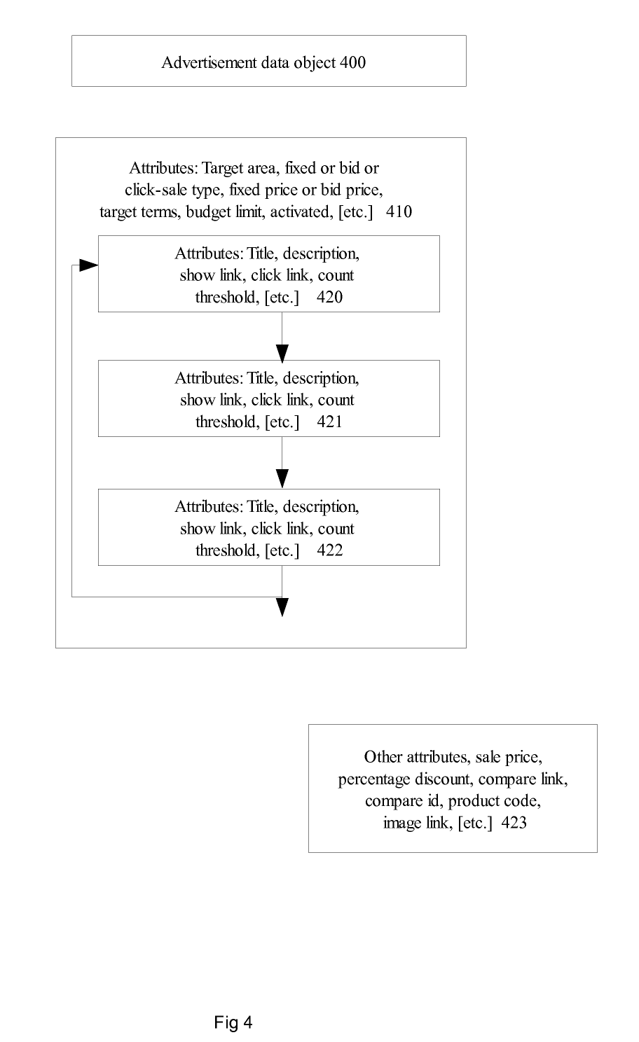

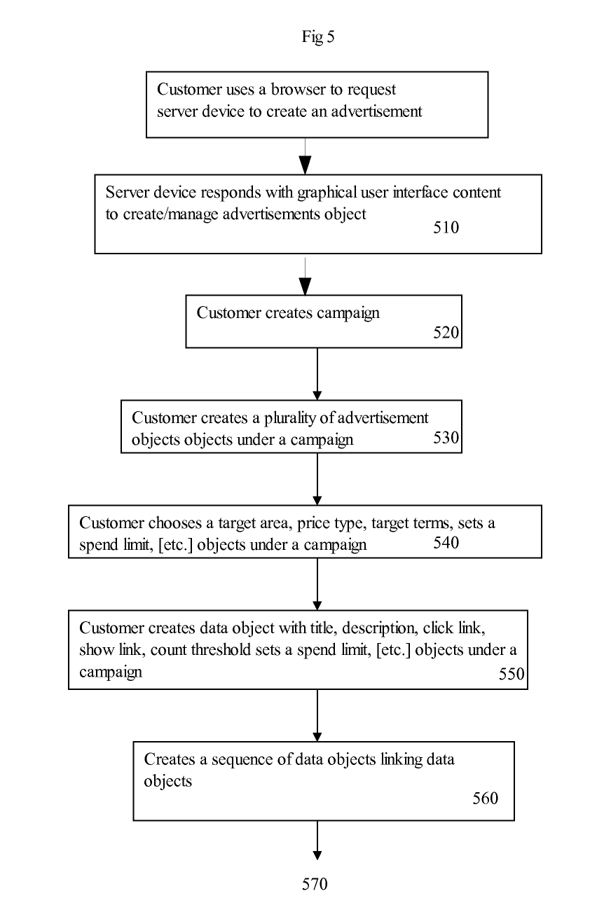

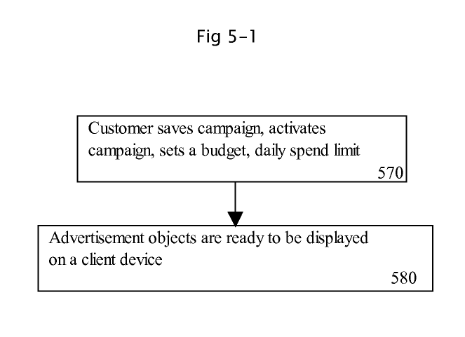

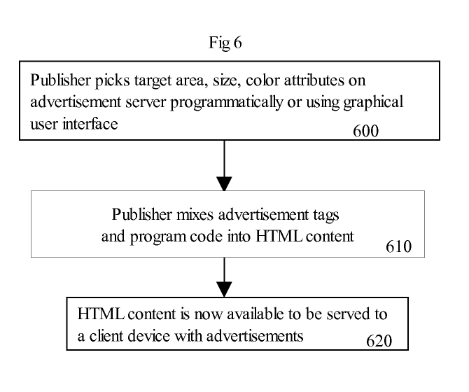

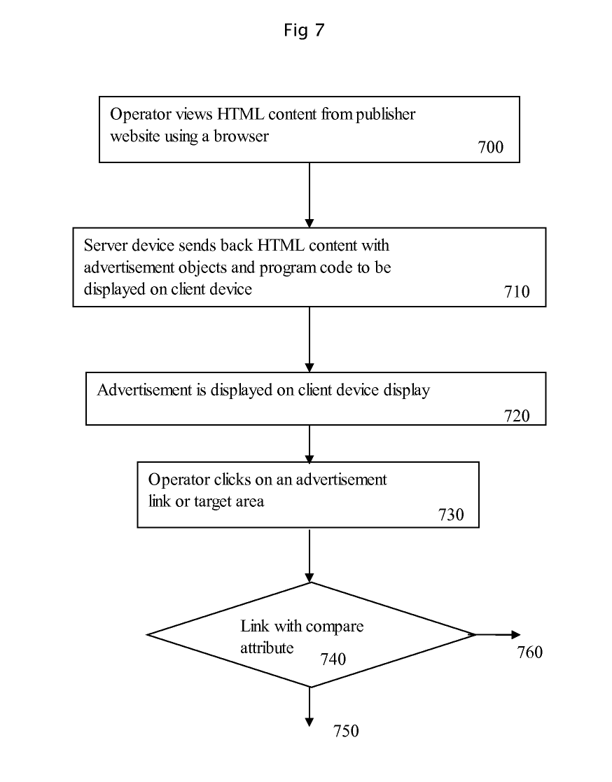

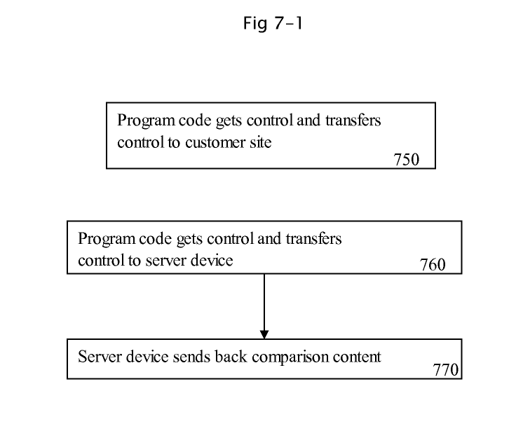

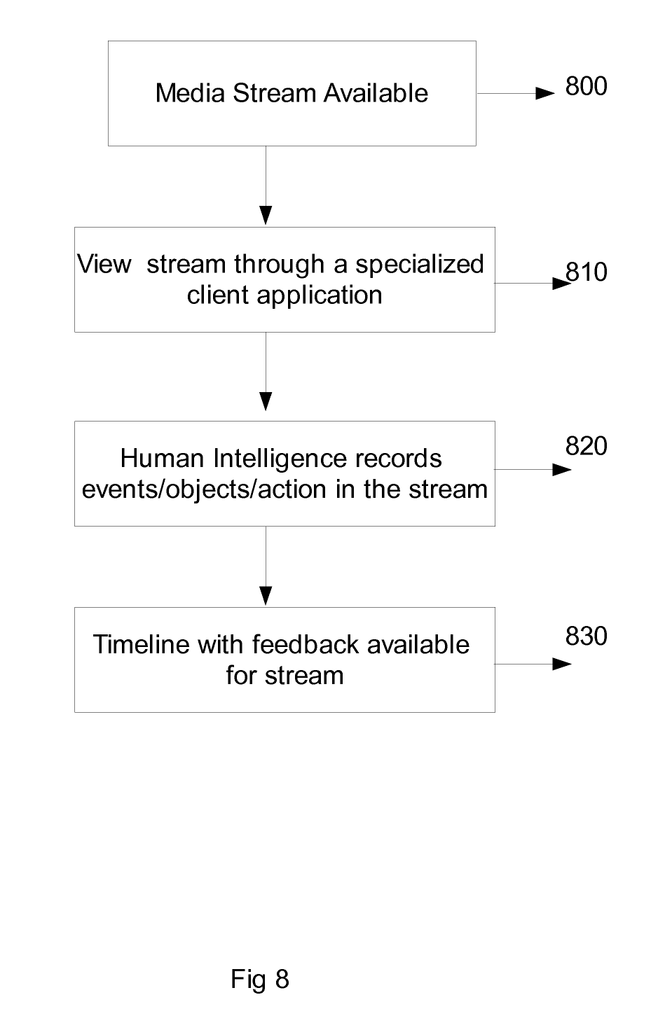

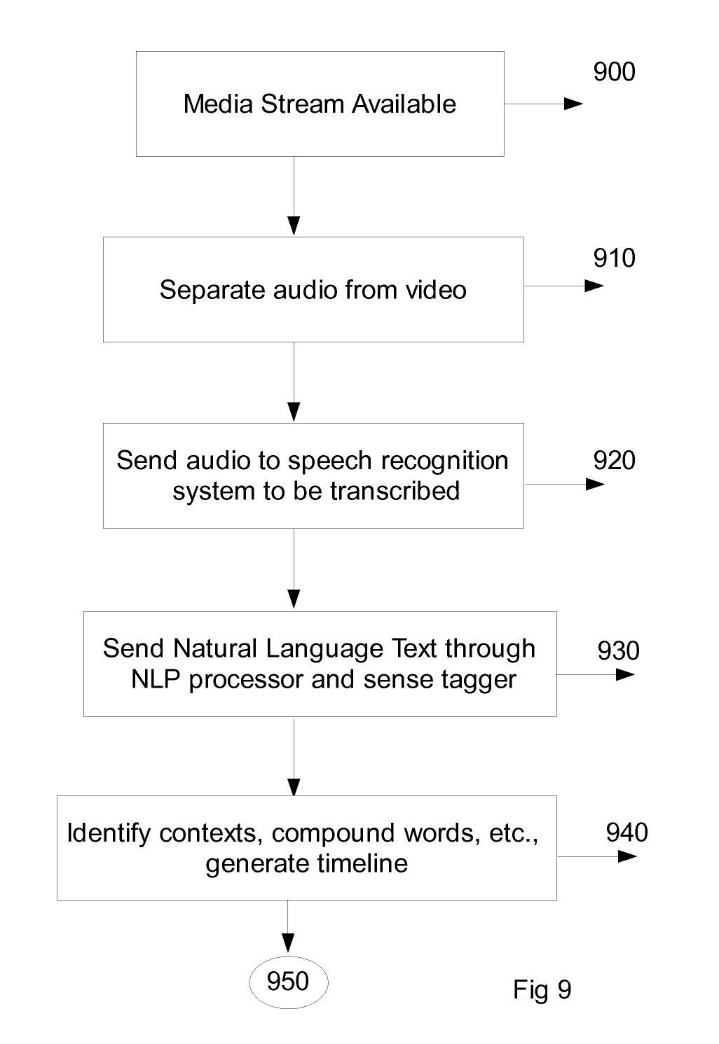

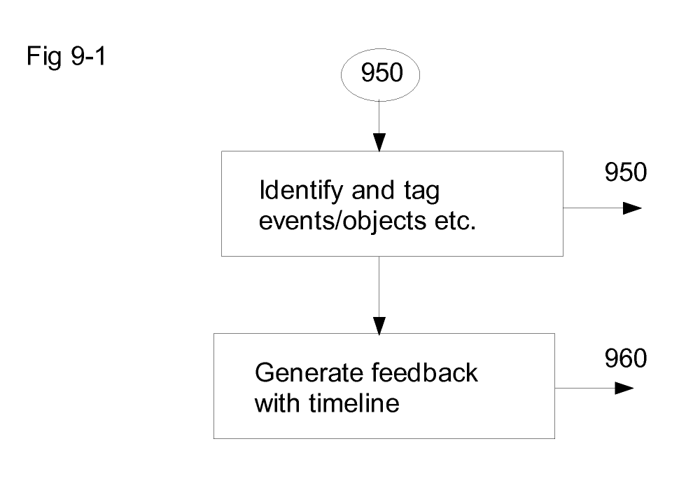

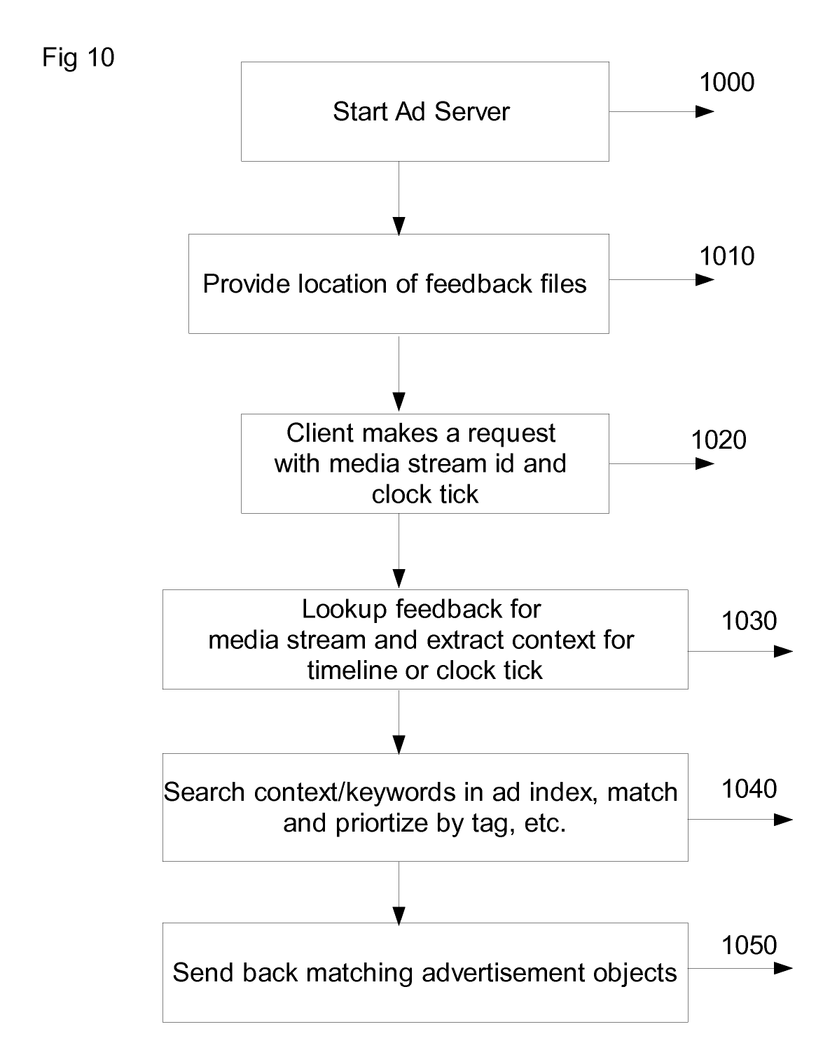

Referring first to FIG. 1, an advertising system 100 according to embodiments of the present invention is shown. As shown in FIG. 1, the advertising system 100 includes a client device 120, a server device 150, an operator or user or viewer of the client device 700. The operator uses the client device 120 and browser application 130 to access a server device by typing the address of the server device into the browser input. The browser communicates request 200 to the server device across the network 140. The server device sends back content to be rendered on the browser. In an embodiment, HTML content is returned by the server device 710. The HTML content includes advertisements to be shown on the display device 220, 720. The advertisements are made up of HTML tags, program code and data objects 210. The program code is loaded through the JavaScript <script> tag with the src attribute pointing to the JavaScript file to be loaded from the server device. The data objects 230 are again loaded using a JavaScript <script> tag with the src attribute pointing to the server device and taking as parameters a target area identifier, query terms, affiliate id, keywords, [etc.] The program code checks if the data objects have been loaded 250 and if so, renders the first data object on to the target area on the display using the size, width, color attributes, [etc.] 260. The data objects of an advertisement are linked such that there is a cyclical structure, the first object pointing to the second, second to the third, and the last to the first in an embodiment. In other embodiments, the data objects can be a list, with a count of number of objects in the list. An index can then be used to access the list. The program code also signs up with the timer service to be triggered at clock intervals 240. On a trigger 270, the program code checks the count threshold 280 if it needs to refresh the display, and if so, gets a reference to the next object and makes that as the current object 290 while rendering the attributes onto the display 260. The cyclical structure of the data objects and the continuous updates at trigger thresholds creates a visual perception of motion to the user or viewer of the display. In an embodiment, if the bundle has content generation by site-owner enabled, instead of rendering content, the program code only tracks performance of the target area and sends back the performance metrics in terms of clicks, impressions, etc. back to the server device. In an embodiment the motion attribute can turned off and streaming attribute enabled in the bundle 281, enabling the program code to communicate with the server device at every clock or at known clock ticks sending back the ticks to the server device 282. The server device on receipt of the tick, looks to identify the request id and see if the timeline objects related to the id are in memory. If these are not in memory, these are loaded from a storage device and an hash structure created to match the tick to a timeline and the associated input feedback 283. Once a feedback input is matched, the server device uses the feedback input to search through an index and returns the matched advertisement data objects back to the client. The server device also includes the next trigger tick from the timeline for the client device to communicate back. The program code on receipt of the data objects on the client device now switches the current objects 290 in the target area with the sent data objects. It also sets itself to communicate back to the server device at the next tick as sent by the server device.

In an embodiment, advertisements are added to HTML content being sent from a server device using a server side program code such as Java. In such a embodiment, the server device which has received a request from a client device 300 with query terms, client attributes, [etc.] as parameters uses a established connection to an advertisement server including the said parameters, a target id, [etc.] and requests advertisements 305. The response from the server which is in the form of XML or JSON is converted to server side program code data objects using a data converter. The converted data objects are linked such that there is a cyclical structure, the first object pointing to the second, second to the third, and the last to the first in an embodiment. In other embodiments, the data objects can be a list, with a count of number of objects in the list. An index can then be used to access the list. The server side program code in the language manipulates the different attributes using the object methods to convert attributes into plain HTML tags and mixes it with the HTML content being sent across to the client device. The mix includes program code to be executed on the client device 310. The program code gets executed 325 on load by the browser 315 in an embodiment enabling the program code to sign up to be triggered on a clock signal 320. On a trigger 330, the said program code makes a XMLHttpRequest to the said server device 335. The server side programming code that is keeping track of the data objects being shown in a target area changes the current object to the next object 345 if count thresholds are crossed 340. The object methods are manipulated again to convert the object attributes to HTML which is sent back to the client device 345, and the program code on the client device renders 325 the HTML sent back onto the display device 350. The cyclical structure of the data objects and the continuous updates at the trigger thresholds creates a visual perception of motion to the user or viewer of the display. In an embodiment, if the bundle has content generation by site-owner enabled, instead of rendering content, the program code only tracks performance of the target area and sends back the performance metrics in terms of clicks, impressions, etc. back to the server device.

In an embodiment, advertisements are sent as data objects along with program code back to the client device. The program code on execution establishes a Server push type connection to the server device. It also signs up with the timer service to be triggered at clock signals. The clock signal trigger as before enables program code to render the data objects onto the display. But after a pre-configured number of iterations, the client code makes a request back to the server device for new set of data objects and the server device responds by sending a new set of data of objects and maybe program code. In other embodiments instead of the program code making a request for new objects, the server device which is keeping track of time on the server side sends back more data objects and maybe program code to the client device allowing the program code to change the data objects being refreshed onto the display with the new data objects received. This type of functionality allows a viewer of the client device to continuously see new data objects on the client device display.

In an embodiment, a media stream object 800 is streamed with a specialized client application in a browser 810 from a server device and the timelines of interesting objects, events, actions are noted using human intelligence 820. Tags are added to the feedback input to prioritize/identify events/objects, add indicators or sensory feedback 830. The tags are parsed at search time so as to override the search results, prioritize an advertisement data object or send back a known advertisement data object with an action such as movie theater tickets or a fashion gown at a discount or a jewelry on sale, etc. In an embodiment, the media stream 900 object's audio stream is separated from the video stream on the server device 910 and the audio stream is sent through a speech recognition system or service to transcribe the audio 920. The transcribed text is sent through a NLP processor with a sense tagger 930. The output of the sense tagger is next analyzed to identify contexts 940 in the natural language text by looking up groups of words in a knowledge source such as wordnet, wikipedia, separate adjectives, form compound words such as combining “small people” to “small_people” and generate synonyms such as lilliput/hobbit, etc., add time lines to the sentence or a paragraph to generate the feedback 960. The end output is meaningful keywords or contexts that can be used to identify events/objects/actions 950 so that contextual advertisement objects can be matched and sent back to the client device. In an embodiment, the events/objects can be associated with a database such that actions can be associated to the object so that a movie object can have tickets associated with it or an entity identified in an event can have a sale object associated, etc. In an embodiment, the feedback file location 1010 is read at start up by the advertisement server application 1000. A request from a client device with the stream id, clock ticks and/or user identifier parameters 1020 will enable loading the feedback associated with the stream into a hash and tree structure and a lookup is made into the data structure to match the timeline 1030, extract the context/keywords with tags and a search initiated to match advertisement data object objects 1040 to return back to the client device 1050. The response from the server device in the form of program code and data objects and display tags which maybe HTML in an embodiment are then rendered as before in target areas on the client device. The program code using the timing mechanism is in sync with the specialized client application and the event stream timeline in an embodiment using an api of the client application enabling advertisement objects to be shown within target area in the client application as well as target areas surrounding the client application. Mixing the advertisement dynamically on the client device enables contextually relevant advertisement to be shown not only within the specialized client application but also outside of it enabling richer monetizing opportunities and for the length of the media stream in real time. Even if the advertisements are turned off within the client application with a turn off mechanism or disabled, the timing mechanism and the program code enable context relevant advertisements to be streamed in real time from the server device to be shown in the surrounding target areas. In an embodiment the program code streaming the advertisement objects makes request back to the server device for more objects and the said server device can be the same device as the one sending back the media stream objects to the specialized client application or a different server device but within the same domain. In another embodiment, the program code streaming the advertisement objects can make requests to a server device that is on a different domain as to the server device streaming the media stream to the specialized client application. The timing mechanism and the program code still enable communication between the specialized client application to show contextually relevant advertisement objects to the media stream in target areas within the specialized client application or outside of it. In this embodiment the request/response is stateless allowing scalability on the server side to handle a plurality of such requests. In other embodiments, the request/response maybe stateful so as to provide a specific experience to a user on a client device.

In an embodiment, instead of speech recognition, an image recognition system can be used to identify objects/events/face, etc. so as to generate the feedback. In other embodiments, a combination of image/speech/human recognition can be used to generate the feedback. In an embodiment the feedback can be dynamically generated from a live stream and communicated to the advertisement server application. In an embodiment, the timing mechanism and program code enable personalized information/location, etc. to be sent back to the server device enabling contextual relevant personalized/location sensitive/cultural/seasonal/relevant advertisements to be sent back.

In an embodiment, an operator of the client display viewing the advertisement data objects may click on a link or click on a target area enabling program code to be executed 730. The executed code enables the browser to request content from the server device in the click link attribute. In an embodiment, the request could transfer control to the content from the server device 750. In other embodiments, the request could be initiated using a new browser window allowing the advertisements and content being shown on the display to still be visible. In an embodiment, a click on a compare link enables the program code to enable the browser to request content from the server device 760 in the compare link passing as parameters a compare id. The server device on receiving the request from the client device with a compare id, responds back with compare content 770 to be displayed on the client display. In an embodiment the content on the client device can be game or a puzzle or a form enabling the user to interact with the content and send back inputs back to the server device. The server device on receipt of such input can transfer control or bring in new content or persist the inputs for processing.

### Advertisement Database

The advertisement data objects created by the customer using the client device are stored on a server side storage device. Each advertisement object is stored in a storage file or as a record on the storage device using a data source. The name of the storage file or key can include advertisement attributes campaign identifier and customer identifier allowing the advertisement objects to be grouped by campaign and customer. In an embodiment an advertisement can be stored as an object itself using an Object converter. The campaign objects are again stored as a storage file or as a record or as an object file. The name of the storage file or key can include the attribute customer identifier allowing the campaign objects to be grouped by a customer. The customer object is again stored as a storage file or as a record or object file. The name of the storage file can include the customer identifier.

The target area data objects created by the site-owner using the client device are again stored on a server side storage device. Each target area object is stored in a storage file or as a record on the storage device using a data source. The name of the storage file or key can include target area identifier, site owner identifier allowing the advertisement objects to be grouped by target area and site-owner. In an embodiment a target area can be stored as an object itself using an Object converter.

When the advertisement server is started, it reads the customer objects, and reads all the campaign objects and further reads all the advertisement objects in a campaign. It organizes the objects by target area, if specified and uses a tree type structure to sort the objects by fixed price and bid price objects. When a request from a client device is received, the target identifier allows the server to identify the tree structure to use. The fixed price type objects have priority over the bid price type and are sent back first. A request parameter includes the number of advertisement objects to be sent back. The id attribute is assigned a unique time stamp so that an advertisement can be tracked before it is sent. An accounting record is created on the server side of sending the advertisement object. The record includes id, advertisement object attributes, and client parameters, [etc.]. The server also keeps track of the objects sent back so as to not send the same objects again. If a fixed price type object daily limits or budget thresholds are crossed then the object is removed from the tree. If there are no more fixed price type objects to be shown, then the highest bid objects for the target area are shown first. If there are no bid objects, then objects with no specific target area are selected to be sent back. In another embodiment, if billing type is cost-per-time and the time has expired the next available advertisement objects are selected. If the request parameters include query terms such as city, product name, search terms, [etc.], the server initiates a query match on an index and returns matching advertising objects containing the terms. In an embodiment this can be the name of the storage file containing the advertising object or a key containing the terms customer id, campaign id and advertisement object id. The server uses the key to search the tree for the advertisement object and adds it to the list of objects to be returned. In an embodiment, the server device at startup can also read from timeline feedback files, reading the time events and the input feedback so as to match incoming clock tick with a time event.

Each impression shown is accounted for on the server device and also on the client device. The display of an advertisement on the client device is kept track of by analyzing the log files to confirm that an advertisement was indeed shown by matching the server side timestamp id and timestamp id sent back by the program code on an advertisement display on the client device. Similarly a click on a target device or a link is accounted for from the log files by matching the ids.

A script is executed on the advertisement server daily that goes through the accounting records and log files to match and account for an advertisement shown, clicked, [etc.]. The performance information by advertisement object, campaign, and customer are generated by the script. A graphical user interface allows the customer to access and view advertisement performance including billing information from a client device. Billing a customer could be through a credit card, ACH, [etc.]

Although the present invention has been described with respect to a preferred embodiment thereof, those skilled in the art will note that various substitutions may be made to those embodiments described herein without departing from the spirit and scope of the present invention. Object attributes, program code, and functions specified and described herein have been selected for clarity of exposition, and do not represent all possible transformations or combinations. Those skilled in the art will also note that although embodiments of the present invention have been described in the context of target areas, timing mechanism, object attributes, program code, display, client device, server device, [etc.] certain features or embodiments may also apply to other forms of advertising not shown or discussed.

While embodiments and applications of this invention have been shown and described, it would be apparent to those skilled in the art having benefit of this disclosure that many more modifications than mentioned above are possible without departing from the inventive concepts herein. The invention, therefore, is not to be restricted except in the spirit of the appended claims.

Definition List 1

| Term | Definition |
|---|---|
| GET | A HTTP method to send/get data from a server |
| POST | A HTTP method to send/get data from a server |
| HTTP | A TCP/IP based text request/response |
| | protocol that allows web browsers to show |
| | data from a server called a web server |
| Session | A J2EE HTTP session object, and provides a |
| | way to identify a user across more than one |
| | page request or visit to a Web site and to |
| | store information about that user. |
| J2EE | Java 2 Platform, Enterprise Edition defines |
| | the standard for developing component- |
| | based multi-tier enterprise applications |
| Jsp | JavaServer Pages technology provides a |
| | simplified, fast way to create dynamic web content |
| URL | Uniform Resource Locator |
| XML | Extensible Markup Language |
| TCP | Transmission Control Protocol |
| IP | Internet Protocol |
| Java | An object oriented programming language |
| MVC | Model View Controller paradigm |
| Web | World wide web, www, also known as the internet |
| Browser | A Graphical User Interface for viewing |
| | content called html on the web |
| Ajax | A technology to dynamically refresh content |
| | onto a browser client |

What is claimed is:

1. A method for monetizing content, including streaming content with advertisements in a computer based system comprising: (a) a client device with a clock signal means, a display means and program code execution means; said clock signal means generates a signal periodically; said client device provides a means for said program code to sign up; said sign up triggers said program code to be executed at said signal; said display shows content; said content can be text or graphics [etc.], (b) a server device that waits for client devices to communicate; said server device sends back a plurality of data objects and program code as response; said program code is executed on said client device; said data object has a plurality of attributes; said attributes make up an advertisement, whereby said program code execution renders said data objects on said client display; said execution also enables program code to sign up with said client device to be triggered at said clock signal; said clock signal trigger enables said program code to be executed and change said data objects on the said display; said execution also enables program code to communicate with said server device; said communication with server device includes parameters clock tick and identifier attributes; said server device uses said clock tick and said identifier attributes to match feedback input and send back more data objects and program code; (c) a site-owner owning content on the client device, said content is retrieved from a server device; said content is created by the site-owner or a partner; said content can be identified by said program code from said server device.

2. The method of claim 1 further comprising, selecting a plurality of target areas on said display by said program code; said target area enables program code to change content on said display without affecting content in other areas on said display.

3. The method of claim 1 further comprising said server device to initiate communication with said program code being executed on said client device; said communication enables server device to send said data objects and program code to said client device.

4. The method of claim 1, wherein said server device sends back data objects with a plurality of attributes; one said attribute allows said program code to count said clock signals; said count attribute enables program code to change data objects or communicate with server device when count thresholds are crossed.

5. The method of claim 2, further comprising trapping clicks on said client device in said target areas or on a link in said target area; said link is an attribute of said data object; said click means maybe an input or pointer device; said click triggers said program code to be executed; said execution enables said client device to communicate and receive content from a server device.

6. The method of claim 2 wherein said program code changes said data objects in said target areas at said clock signal and said count thresholds, whereby said cyclic change on said display creates a perception of change.

7. The method of claim 5, further comprising tracking said clicks, counts and client attributes; said clicks, counts and client attributes are communicated back to said server device by said program code; said server device persists these said clicks, counts and client attributes.

8. The method of claim 7 wherein, said clicks, counts and client attributes are used to bill customers for the advertisements shown on said client device; said customers create said data objects sent by the said server device; said customers use a client device communicating across a network to access said server device; said communication enables said server device to send across content enabling customers to create said data objects with a plurality of attributes;
wherein said data objects created have at least attributes title, description, a shown link, a click link, a trigger count, target area, target terms, a bid price or fixed price or click-to-sale type or cost-per-time, a reference to another data object;
wherein said content sent back by said server device enables customer to connect data objects together; said connections enable said program code to change data objects at said clock and count triggers;
wherein said attribute fixed price can be configured on said server device; said fixed price can be increased or decreased based on demand and target area where data objects are to be displayed; said fixed price has priority over said bid price; said priority determines showing data object with fixed price type even when there is a competing data object with a higher price of bid price type;
wherein said attribute bid price is set by a forward auction; said bid price increases or decreases through customer bidding;
wherein, said data object with a plurality of attributes may also include attributes a sale price, a discount percentage, a compare link, a compare identifier, image link, [etc.];
wherein said attribute link is a communication identifier comprising of an address; said address may include numbers and text.

9. The method of claim 1, further comprising said client device sends said query terms to said server device; wherein said server device uses said query term to match attributes target terms, title, description, [etc.] in said data objects and send back matching data objects relevant to query terms.

10. The method of claim 5 wherein, a click is trapped in a target area; said click maybe on a link displayed in said target area; said link type maybe a compare link; said link type enables said client device to communicate with a server device with at least said compare identifier as a parameter; said compare identifier enables said server device to send back comparison content to the client device; said comparison content may further include a plurality of customer links.

11. The method of claim 8, wherein a customer is billed; said billing is per impression or per click or click-to-sale or cost-per-time; said billing type is fixed or bid or click-to-sale; said impression is content rendered on client device a plurality of times; said per click is a click in said target area; said click-to-sale is a sale resulting from a said click; said cost-per-time is a monetizing by time; said time maybe seconds, days, weeks, months, quarters, years.

12. The method of claim 1 wherein, said advertisement is text or graphics and may include sound.

13. The method of claim 2, wherein said target area is an area on said display; said area allows said content to be displayed without affecting other content on said display.

14. The method of claim 1 further comprising, identifying a plurality of target areas on said client device by site-owner and creating said target areas on said server device; said target area is a display area on said client device; said target area has a plurality of attributes; said target area has at least attributes, “target area type”, cost type, billing type, billing frequency, billing period, motion, content generation, dimension, content type, display and layout attributes; said “target area type” attribute enables plurality of target area behaviors to be created; said attributes billing type, cost type, billing frequency, billing period allow target area to be monetized; said content type enables different types of content like text/graphics/media/sensory output to be rendered in said target area; said attribute content generation type allows said site-owner content/partner or advertisement content to be rendered in target area; said site-owner adds program code generated by server device to content shown on client device; said program code allows target area to be identified; said program code allows said content sent by server device to be rendered in said target area.

15. The method of claim 1 further comprising, said feedback input is a collection of timelines and contexts; said timeline is a period in time identifying the feedback input; said context describes events, objects and actions associated with the timeline; said actions describes input and output; said input is user input communicated back to the server device from said client device and said output is output communicated to the user of the said client device; said action also describes prioritization of events and objects; said context enables matching data objects to be communicated back to said client device; said data objects may include said actions.

16. The method of claim 1 further comprising, said clock ticks is an identifier in time space tracking time elapsed on the client device and said identifier attributes are attributes describing the client device, application, location, user, [etc.].

17. The method of claim 15 further comprising, said feedback input is generated with human and machine intelligence.

18. The method of claim 1 further comprising, said clock signal means and program code execution on said client device enable real time communication with said server device.

19. The method of claim 1, wherein said client device maybe a general purpose computer; said client device executes a client application that can connect to a server device across a network; said client application can render content and execute program code sent back by server device.

20. The method of claim 1, wherein said server device maybe a general purpose computer; said server device executes a server application that accept requests from a plurality of client devices across a network and sends back a response.
